(19) United States
(12) Patent Application Publication
(10) Pub. No.: US 2013/0300688 A1
(43) Pub. Date: Nov. 14, 2013

(54) INFORMATION PROCESSING APPARATUS, INFORMATION PROCESSING METHOD, AND PROGRAM

(71) Applicant: SONY CORPORATION, Tokyo (JP)

(72) Inventor: Shinji INAMOTO, Tokyo (JP)

(73) Assignee: SONY CORPORATION, Tokyo (JP)

(21) Appl. No.: 13/855,838

(22) Filed: Apr. 3, 2013

(30) Foreign Application Priority Data
May 9, 2012 (JP) 2012107318

(51) Int. Cl. G06F 3/041

(52) U.S. Cl. CPC G06F 3/0416
USPC 345/173

(57) ABSTRACT

There is provided an information processing apparatus including a position detector configured to detect a position of an operating object as a detection position, a state detector configured to detect a state of the operating object as a detection state, and a selection part configured to select any one of a plurality of objects based on the detection position, the detection state, and a priority calculation technique associated with each of the plurality of objects.

### BACKGROUND

The present disclosure relates to an information processing apparatus, an information processing method, and a program.

In recent years, touch panel terminals, as typified by smartphones, are gaining widespread use. For example, an input using a touch panel terminal is performed by using mainly a software keyboard. However, there are cases where objects on the software keyboard are placed close together, for example, and hence, a wrong object may be selected.

Accordingly, in order to reduce the erroneous selection, there are various technologies related to the input using a software keyboard. For example, there is a technology for displaying a character string corresponding to a button that a finger touched in an upper part, and fixing the input of the character string by releasing the finger therefrom (for example, see JP 2010-134719A). Further, there is a technology for reducing the number of buttons by using an input by a flick operation (hereinafter, may also be simply referred to as “flick input”). In addition, there is also a technology for suppressing the occurrence of erroneous selection by correcting a specified position based on individual characteristics (for example, physical characteristics, habit, and operation history) (for example, see JP 2008-242958A).

### SUMMARY

However, in the technology described in JP 2010-134719A, a user has to confirm the display at the upper part for each input, and hence, the input speed may be decreased. Further, regarding the flick input, since some individual preferences or some languages used by individuals are suitable for the flick input and other individual preferences or some languages used by individuals are not suitable, there may be cases where the input speed may be decreased. Still further, in the technology for correcting a specified position based on individual characteristics, the input speed may be decreased in the case where objects are placed close together, for example.

In light of the foregoing, it is desirable to provide a novel and improved technology for suppressing decrease in input speed for selecting an object regardless of the density of objects.

According to an embodiment of the present disclosure, there is provided an information processing apparatus which includes a position detector configured to detect a position of an operating object as a detection position, a state detector configured to detect a state of the operating object as a detection state, and a selection part configured to select any one of a plurality of objects based on the detection position, the detection state, and a priority calculation technique associated with each of the plurality of objects.

According to another embodiment of the present disclosure, there is provided an information processing method which includes detecting a position of an operating object as a detection position, detecting a state of the operating object as a detection state, and selecting any one of a plurality of objects based on the detection position, the detection state, and a priority calculation technique associated with each of the plurality of objects.

According to another embodiment of the present disclosure, there is provided a program for causing a computer to function as an information processing apparatus including a position detector configured to detect a position of an operating object as a detection position, a state detector configured to detect a state of the operating object as a detection state, and a selection part configured to select any one of a plurality of objects based on the detection position, the detection state, and a priority calculation technique associated with each of the plurality of objects.

According to the embodiments of the present disclosure described above, the decrease in input speed for selecting an object can be suppressed regardless of the density of objects.

### BRIEF DESCRIPTION OF THE DRAWINGS

FIG. 1 is a diagram illustrating an overview of an information processing apparatus according to an embodiment of the present disclosure;

FIG. 2 is a block diagram showing a functional configuration example of the information processing apparatus;

FIG. 3 is a diagram illustrating an example of a button selection function;

FIG. 4 is a diagram showing a relationship among a detection position, a detection state, and a button to be selected;

FIG. 5 is a diagram showing an example of display of buttons;

FIG. 6 is a diagram showing an example of display of buttons;

FIG. 7 is a diagram showing an example of display of buttons;

FIG. 8 is a diagram showing an example of display of buttons;

FIG. 9 is a flowchart showing an example of a flow of operation performed by the information processing apparatus;

FIG. 10 is a diagram illustrating a specific example of the button selection function;

FIG. 11 is a diagram showing a recognition region of a specific button under a specific detection state;

FIG. 12 is a flowchart showing an example of a flow of operation performed by the information processing apparatus in a case of executing multiple inputs; and

FIG. 13 is a flowchart showing an example of a flow of operation performed by the information processing apparatus in a case of executing multiple inputs.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, there are some cases where multiple structural elements that have substantially the same function and structure are distinguished from one another by being denoted with different alphabets after the same reference numeral. Note that, in the case where it is not necessary to distinguish the multiple structural elements that have substantially the same function and structure from one another, the multiple structural elements are denoted with the same reference numeral only.

Further, the “detailed description of the embodiments” will be described in the following order.

1. Embodiment
1-1. Overview of Information Processing Apparatus
1-2. Functional Configuration of Information Processing Apparatus
1-3. Button Selection Function
1-4. Display of Buttons
1-5. Operation of Information Processing Apparatus
1-6. Specific Example of Button Selection Function
1-7. Operation of Information Processing Apparatus (Multiple Inputs)

2. Conclusion

### 1. EMBODIMENT

An embodiment of the present disclosure will be described sequentially in detail.

<1-1. Overview of Information Processing Apparatus>

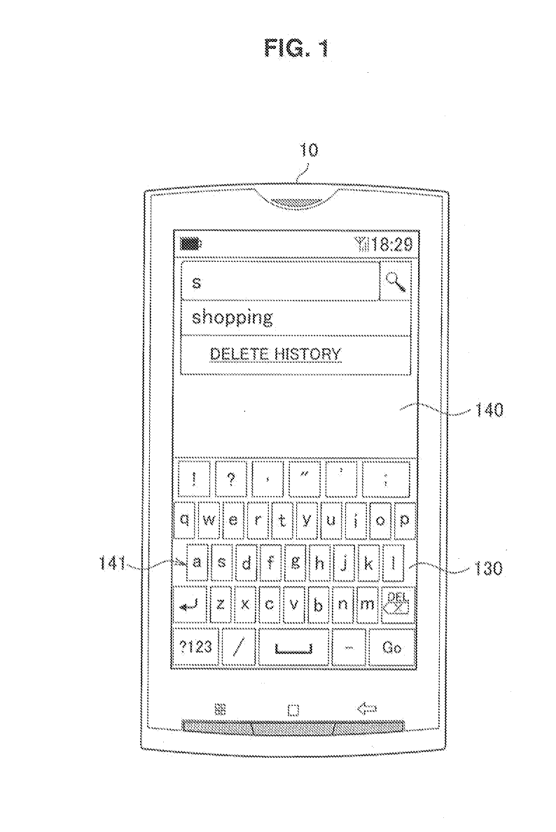

First, an overview of an information processing apparatus 10 according to an embodiment of the present disclosure will be described. FIG. 1 is a diagram illustrating an overview of the information processing apparatus 10 according to an embodiment of the present disclosure.

As shown in FIG. 1, the information processing apparatus 10 includes, for example, a detection device 130 and a display part 140. However, the detection device 130 and the display part 140 may be provided outside the information processing apparatus 10. Further, in the example shown in FIG. 1, a case is assumed where the detection device 130 is a touch panel which detects contact of an operating object, but the detection device 130 may also be a touch panel which detects proximity of the operating object, or may also be a sensor (for example, infrared sensor or pressure sensor) other than the touch panel, which has a function of detecting the operating object. The operating object may be a finger of a user or another item that is other than the finger.

Further, in the example shown in FIG. 1, a case is assumed where the information processing apparatus 10 is a smartphone, but the type of the information processing apparatus 10 is not limited to the smartphone. For example, the information processing apparatus 10 may be a mobile phone, a personal digital assistant (PDA), or another mobile terminal. Further, the type of the information processing apparatus 10 may be other than the mobile terminal. In FIG. 1, although a case is shown where the detection device 130 and the display part 140 are stacked, the detection device 130 and the display part 140 may not be stacked.

Note that, hereinafter, buttons are used as examples of the objects, but the buttons are merely examples of the objects. Accordingly, a button in the description below can be applied to any object that can be displayed on the display part 140, and, for example, the object may be an object (for example, an image, an icon, or a text) other than the button.

Here, as shown in FIG. 1, the display part 140 displays a button group 141. The button group 141 includes multiple buttons (for example, button “q” and button “w”). The respective positions of the multiple buttons may be defined by an operating system, and may be defined by an application.

When the operating object is detected by the detection device 130, the information processing apparatus 10 selects a button based on a detection position of the operating object. However, for example, in the case where the buttons are placed close together as the example shown in FIG. 1, erroneous selection easily occurs in the button selection taking into account only the detection position, and hence, the input speed for selecting a button is decreased.

Accordingly, the present specification suggests a technique for suppressing decrease in input speed for selecting a button regardless of the density of buttons.

Heretofore, an overview of the information processing apparatus 10 according to the embodiment of the present disclosure has been described. Next, a functional configuration example of the information processing apparatus 10 according to the embodiment of the present disclosure will be described.

<1-2. Functional Configuration of Information Processing Apparatus>

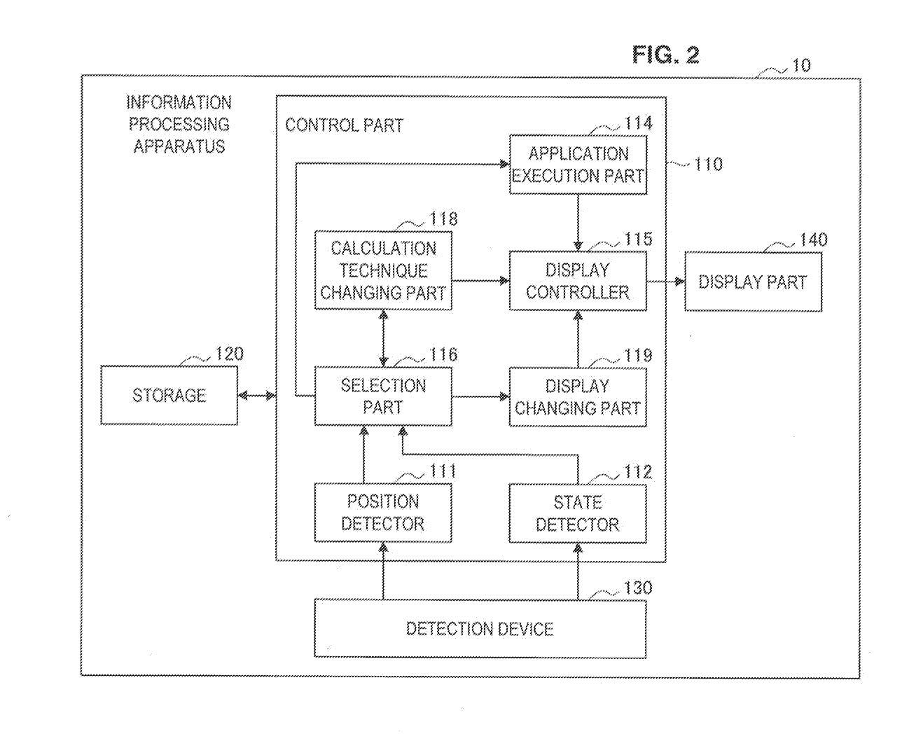

FIG. 2 is a block diagram showing a functional configuration example of the information processing apparatus 10 according to the embodiment of the present disclosure. As shown in FIG. 2, the information processing apparatus 10 includes a control part 110, a storage 120, a detection device 130, and a display part 140. Further, the control part 110 includes a position detector 111, a state detector 112, an application execution part 114, a display controller 115, a selection part 116, a calculation technique changing part 118, and a display changing part 119.

The control part 110 corresponds to a processor such as a central processing unit (CPU) or a digital signal processor (DSP). The control part 110 exhibits various functions of the control part 110 by executing a program stored in the storage 120 or another storage medium.

The storage 120 stores a program for processing performed by the control part 110 and data in a storage medium such as semiconductor memory or a hard disk. For example, the storage 120 can also store an application executed by the application execution part 114. In the example shown in FIG. 2, the storage 120 is built in the information processing apparatus 10. However, the storage 120 may also be provided separately from the information processing apparatus 10.

The detection device 130 detects an operating object. A detection result of the operating object detected by the detection device 130 is output to the control part 110. As described above, the detection device 130 may be included in the information processing apparatus 10, and may be provided outside the information processing apparatus 10. Further, as a technique for detecting the operating object by the detection device 130, various techniques may be used depending on the type of the detection device 130.

The position detector 111 detects the position of the operating object as the detection position. In more detail, the detection position of the operating object output from the detection device 130 is detected by the position detector 111. The detection position detected by the position detector 111 is output to the selection part 116, and is used for selecting a button pressed by a user. Note that the detection position may also be used for detection of a detection state performed by the state detector 112. The detection position detected by the position detector 111 corresponds to an example of input information.

The state detector 112 detects the state of the operating object as the detection state. The detection state is not particularly limited. For example, the detection state may include at least one of a time taken to detect the operating object by the detection device 130 (hereinafter, also simply referred to as “detection time”), a pressure applied by the operating object to the detection device 130 (hereinafter, also simply referred to as “pressure”), and a contact area between the detection device 130 and the operating object (hereinafter, also simply referred to as “contact area”). That is, the detection state may be the detection time, the pressure, the contact area, or any combination thereof.

The detection state detected by the state detector 112 is output to the selection part 116, and may be used for selecting a button pressed by a user. The detection state detected by the state detector 112 corresponds to an example of input information.

The selection part 116 selects any one of multiple buttons based on the detection position, the detection state, and a priority calculation technique associated with each of the multiple buttons. The button selected by the selection part 116 is output to the application execution part 114 as the button pressed by the user. The priority calculation technique corresponds to a technique of calculating a priority of a button associated with the priority calculation technique. With increase in a priority of a button, it becomes more likely that the button is selected.

For example, the selection part 116 selects any one of the multiple buttons based on the thus defined position of each button, the detection position, the detection state, and the priority calculation technique associated with each of the multiple buttons. In addition, the selection part 116 may perform calibration based on a history of input information, and may select any one of the multiple buttons based on a result of the calibration.

The application execution part 114 executes an application based on the button selected by the selection part 116. For example, in the example shown in FIG. 1, a letter input to the application in the case where the selection part 116 selects the button “q” is different from a letter input to the application in the case where the selection part 116 selects the button “w”. As described above, the type of the application is not particularly limited. The application execution part 114 outputs an execution result of the application to the display controller 115.

The display controller 115 controls the display part 140 to display each button on the display part 140. In the example shown in FIG. 1, the display part 140 displays the button group 141. Further, the display controller 115 may control the display part 140 to display an application execution screen on the display part 140 based on the execution result output from the application execution part 114. Note that, as described above, the application execution screen may be displayed on a display part that is different from the display part 140.

The display part 140 displays each button in accordance with control performed by the display controller 115. Further, the display part 140 may also display the application execution screen in accordance with control performed by the display controller 115. As described above, the display part 140 may be included in the information processing apparatus 10, or may be provided outside the information processing apparatus 10. Note that the display part 140 includes a liquid crystal display (LCD), an organic electroluminescence (EL) display device, and the like.

Heretofore, a functional configuration example of the information processing apparatus 10 according to the embodiment of the present disclosure has been described. Next, an example of a button selection function of the selection part 116 will be described.

<1-3. Button Selection Function>

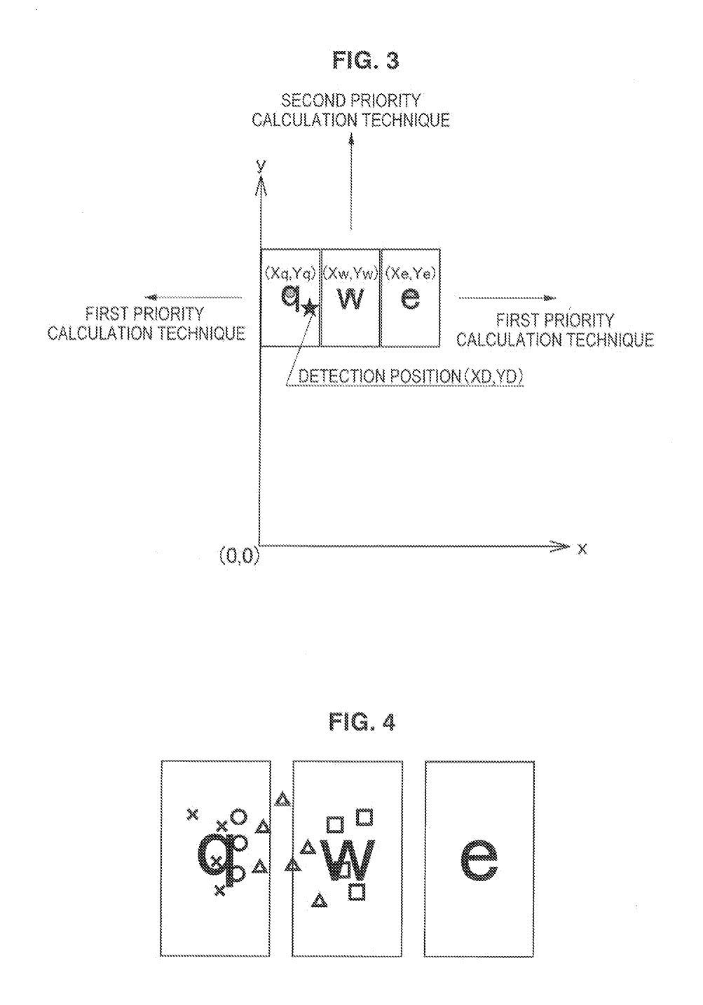

FIG. 3 is a diagram illustrating an example of a button selection function. Note that, for simplicity of the description, FIG. 3 shows a recognition region of a part (a button “q”, a button “w”, and a button “e”) of the button group 141 shown in FIG. 1. As shown in FIG. 3, each button is associated with a priority calculation technique. To be specific, the button “q” is associated with a first priority calculation technique, the button “w” is associated with a second priority calculation technique, and the button “e” is associated with the first priority calculation technique.

The first priority calculation technique and the second priority calculation technique are common in that they are each a technique that calculates a priority using a detection state, but are different priority calculation techniques. Here, for example, a case is assumed where the first priority calculation technique is a technique that calculates the priority to be higher as the pressure decreases, and the second priority calculation technique is a technique that calculates the priority to be higher as the pressure increases. However, the detection state is not limited to the pressure.

For example, the first priority calculation technique may be a technique that calculates the priority to be higher as the detection time decreases, and the second priority calculation technique may be a technique that calculates the priority to be higher as the detection time increases. Further, for example, the first priority calculation technique may be a technique that calculates the priority to be higher as the contact area decreases, and the second priority calculation technique may be a technique that calculates the priority to be higher as the contact area increases.

Here, as shown in FIG. 3, with the use of xy-coordinates, a detection position is represented by (XD,YD), a position of the button “q” is represented by (Xq,Yq), a position of the button “w” is represented by (Xw,Yw), and a position of the button “e” is represented by (Xe,Ye). The selection part 116 selects any one of multiple buttons based on: the position of the button “q” (Xq,Yq), the position of the button “w” (Xw,Yw), and the position of the button “e” (Xe,Ye); the detection position (XD,YD); the detection state; and the priority calculation technique associated with each of the multiple buttons.

In more detail, the selection part 116 calculates the priority of each of the multiple buttons based on the detection state and the priority calculation technique associated with each of the multiple buttons. As described above, with increase in the priority of a button, it becomes more likely that the button is selected. Further, the selection part 116 calculates distances from the respective positions of the multiple buttons (Xq,Yq), (Xw,Yw), and (Xe,Ye) to the detection position (XD,YD). With decrease in the distance between the detection position and a button, it becomes more likely that the button is selected. The selection part 116 selects a button taking into account both the priority and the distance.

In this way, in the present embodiment, a button is selected taking into account both the priority and the distance. For example, let us assume that the button “q” is a button in which the priority is calculated to be higher as the pressure decreases. In this case, a user can specify the button “q” without worrying about the detection position being shifted from the position of the button “q”, by applying a smaller pressure. Accordingly, the input speed for selecting the button can be increased compared to the case of selecting the button “q” taking only the distance into account.

On the other hand, let us assume that the button “w” is a button in which the priority is calculated to be higher as the pressure increases, for example. In this case, a user can specify the button “w” without worrying about the detection position being shifted from the position of the button “w”, by applying a greater pressure. Accordingly, the input speed for selecting the button can be increased compared to the case of selecting the button “w” taking only the distance into account.

The priority and the distance may be taken into account in any ways. For example, the selection part 116 may select a button based on a result obtained by representing the highness of the priority and the shortness of the distance by the respective scores, and multiplying the scores. For example, the selection part 116 may select the button having the result with the highest value. Further, for example, the selection part 116 may select a button based on a result obtained by adding the scores. For example, the selection part 116 may select the button having the result with the highest value.

Note that the priority calculation technique associated with each button is not particularly limited. For example, in the example shown in FIG. 3, the button “q” is associated with the first priority calculation technique, the button “w” is associated with the second priority calculation technique, and the button “e” is associated with the first priority calculation technique. As this example shows, each of the multiple buttons may be associated with the priority calculation technique that is different from the priority calculation technique with which the adjacent button is associated. In this way, with the arrangement in which the first priority calculation technique and the second priority calculation technique are placed alternately, the possibility of occurrence of button erroneous selection can be further reduced, and therefore, the input speed for selecting a button can be further increased.

However, the first priority calculation technique and the second priority calculation technique may not be arranged alternately. For example, the priority calculation techniques may be arranged freely based on factors such as software, hardware, and a user. For example, a button placed at a position that the user is apt to touch by mistake, a button which may cause a disadvantageous effect if touched by mistake, or the like may be set in a manner that the recognition region is extremely decreased unless the pressure is increased.

Further, in the example shown in FIG. 3, there are two the types of priority calculation techniques, the first priority calculation technique and the second priority calculation technique, but the number of types of priority calculation techniques may be three or more. For example, the degree of detection state may be classified into three stages, and, when the detection state is in a first stage, the priority calculated by the first priority calculation technique may become higher, when the detection state is in a second stage, the priority calculated by the second priority calculation technique may become higher, and when the detection state is in a third stage, the priority calculated by a third priority calculation technique may become higher.

Further, the number of detection states used for the priority calculation may be two or more. For example, there may be provided a priority calculation technique that calculates the priority to be higher as the contact area decreases and the priority to be higher as the detection time decreases, and a priority calculation technique that calculates the priority to be higher as the contact area increases and the priority to be higher as the detection time increases. In this case, for example, it becomes possible to grasp more accurately the user's intention, because when the touch panel is touched lightly with a fingertip, not only the detection time is shortened, but also the contact area tends to become smaller.

In addition, as described above, by performing calibration, it is also possible to acquire characteristic information of an individual and characteristic information in each state, and to enhance the accuracy of determination using those pieces of characteristic information. That is, the selection part 116 can also select any one of multiple buttons based on a detection position detected by the position detector 111, a detection state detected by the state detector 112, a detection history, and a priority calculation technique of each of the multiple buttons.

The detection history is not particularly limited, and the detection history may include a history of detection position(s) which has(/have) been previously detected by the position detector 111, for example. In this case, for example, the selection part 116 may correct a detection position detected by the position detector 111 based on the history of detection position(s), and may select any one of multiple buttons based on the detection state detected by the state detector 112, the corrected detection position, and the priority calculation technique of each of the multiple buttons. Further, such correction may be performed for each selected button.

In more detail, for example, in the case where there are one or more detection positions which have been previously detected, the selection part 116 may calculate a shift amount between an average of the one or more detection positions and a position of a button selected in each detection, and may perform correction of shifting the detection position (XD,YD) by the shift amount.

Further, the detection history may include a history of detection state(s) which has(/have) been previously detected by the state detector 112. In this case, for example, the selection part 116 may correct a detection state detected by the state detector 112 based on the history of detection state(s), and may select any one of multiple buttons based on the detection position detected by the position detector 111, the corrected detection state, and the priority calculation technique of each of the multiple buttons. Such correction may also be performed for each selected button.

In more detail, for example, in the case where there are one or more detection states which have been previously detected, the selection part 116 may calculate an average of the one or more detection states, and may perform correction of the detection state depending on the average. For example, when the average exceeds a range of the detection state that is set in advance (for example, range of the detection state in the case where a general user touches a touch panel), the selection part 116 may perform correction in a manner that the detection state is decreased. Further, for example, when the average is less than the range of the detection state that is set in advance, the selection part 116 may perform correction in a manner that the detection state is increased.

Further, a priority calculation technique associated with at least one of the multiple buttons may be changed to a different priority calculation technique by the calculation technique changing part 118. The type of the detection state used by the post-change priority calculation technique and the type of the detection state used by the pre-change priority calculation technique may be the same as or different from each other. By making the changing of priority calculation techniques possible, it is expected that a button can be selected in accordance with a preference or a habit of a user, and that the user can comfortably specify a button. Further, the possibility of occurrence of erroneous selection is also reduced.

For example, the calculation technique changing part 118 may also change a priority calculation technique based on a user operation. A case is assumed where the user operation is detected by the detection device 130, for example. However, the user operation may also be detected by a device other than the detection device 130. For example, in the case where a button is specified by a user operation, the calculation technique changing part 118 changes the priority calculation technique of the button. The number of buttons specified by the user operation may be one, or may be two or more.

Further, the changing of priority calculation techniques is not limited to the changing based on the user operation. For example, the calculation technique changing part 118 may change a priority calculation technique based on a detection history of the operating object detected by the detection device 130. The detection history may include at least one of the history of detection position(s) previously detected by the position detector 111 and the history of detection state(s) previously detected by the state detector 112.

For example, the calculation technique changing part 118 may identify priority calculation techniques associated with respective multiple buttons based on the history of detection state(s), and may select any one of the multiple buttons based on the detection position, the detection state, and the identified priority calculation technique. In more detail, for example, in the case where there are one or more detection states which have been previously detected, the calculation technique changing part 118 may calculate an average of the one or more detection states, and may determine the priority calculation technique depending on the average. For example, when the average exceeds a range of the detection state that is set in advance, the calculation technique changing part 118 may change the priority calculation technique.

Further, the calculation technique changing part 118 may change the priority calculation technique based on a history of correction(s) that the user performed on a button previously selected by the selection part 116. For example, in the case where correction of deleting a letter corresponding to a selected button has been performed, the calculation technique changing part 118 may determine that the selection of the button was an erroneous selection, and may change the priority calculation technique associated with the button.

It should be noted that, in the case where the number of letters in a character string to be corrected is more than a predetermined number of letters (for example, in the case where the number of letters in the character string to be corrected is two or more), the calculation technique changing part 118 may determine that the selection of the button is not erroneous selection. This is because the correction may have been performed for text editing, and the selection of the button may not be erroneous selection. Further, the calculation technique changing part 118 may determine whether to change a priority calculation technique depending on a frequency of corrections. For example, in the case where the frequency of corrections exceeds a predetermined amount, the calculation technique changing part 118 may change the priority calculation technique associated with the button.

Next, there will be described advantageous effects achieved by the button selection performed by the selection part 116.

FIG. 4 is a diagram showing a relationship among a detection position, a detection state, and a button to be selected. In the same manner as described above, in the example shown in FIG. 4, a case is assumed where the button “w” is associated with a priority calculation technique that calculates the priority to be higher as the pressure increases. In this case, for example, when the pressure is greater, the positions of “Δ” on the button “q” are within the range of the recognition region of the button “w”. In addition, depending on the priority calculation technique associated with the button “w” and the pressure, the positions of “∘” shown in FIG. 4 are also within the range of the recognition region of the button “w”. On the other hand, when the pressure is smaller, the positions of “Δ” shown in FIG. 4 are outside the range of the recognition region of the button “w”.

In the same manner as described above, in the example shown in FIG. 4, a case is assumed where the button “q” and the button “e” are each associated with a priority calculation technique that calculates the priority to be higher as the pressure decreases. In the case where positions at or near halfway between the button “q” and the button “w”, such as the positions of “Δ” shown in FIG. 4, are pressed, the selection part 116 selects the button “w” when the pressure is greater, and selects the button “q” when the pressure is smaller.

Further, in the case where the detection position is at or near the center of the button “q”, such as the positions of “x” shown in FIG. 4, the selection part 116 selects the button “q” regardless of the pressure. On the other hand, in the case where the detection position is at or near the center of the button “w”, such as the positions of “□” shown in FIG. 4, the selection part 116 selects the button “w” regardless of the pressure. In the case where the detection position is a certain distance away from the button “w”, such as the positions of “∘” shown in FIG. 4, the selection part 116 selects the button “w” when the pressure is rather great.

Heretofore, an example of the button selection function of the selection part 116 has been described. It should be noted that, each button is associated with a priority calculation technique as described above, and if a user can intuitively grasp the association between the button and the priority calculation technique, the user can easily specify a button. Hereinafter, there will be described a technique for allowing the user to grasp the association between a button and a priority calculation technique.

<1-4. Display of Buttons>

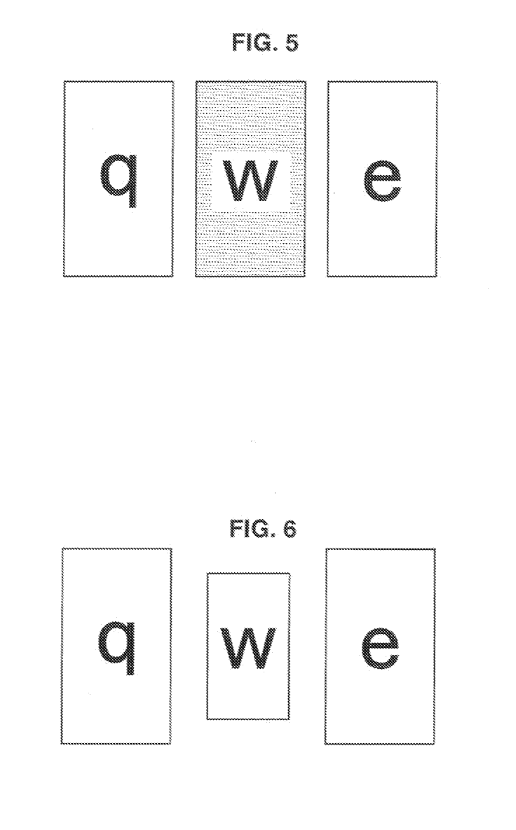

FIGS. 5 to 8 are diagrams each showing an example of display of buttons. Note that, for simplicity of the description, FIGS. 5 to 8 each show a part (a button “q”, a button “w”, and a button “e”) of the button group 141 shown in FIG. 1. The display controller 115 controls the display of buttons in a manner that a display of at least one button out of multiple buttons is a display corresponding to the priority calculation technique associated with the button. Here, a case is assumed where the control is performed such that the displays of all of the multiple buttons are the displays corresponding to priority calculation techniques, respectively.

The mode of button display which the display controller 115 controls may include at least one of colors, sizes, shapes, orientations, and placements of buttons. For example, the mode of button display to be controlled by the display controller 115 may be the colors of the buttons. For example, there is assumed a button display in which the colors of the buttons are different from each other depending on the priority calculation techniques associated therewith. In the example shown in FIG. 5, the color of the button “q” and the button “e” which are associated with the first priority calculation technique is different from the color of the button “w” which is associated with the second priority calculation technique. For example, the color of a button that needs to be pressed hard may be a dark color and the color of a button that needs to be pressed softly may be a light color.

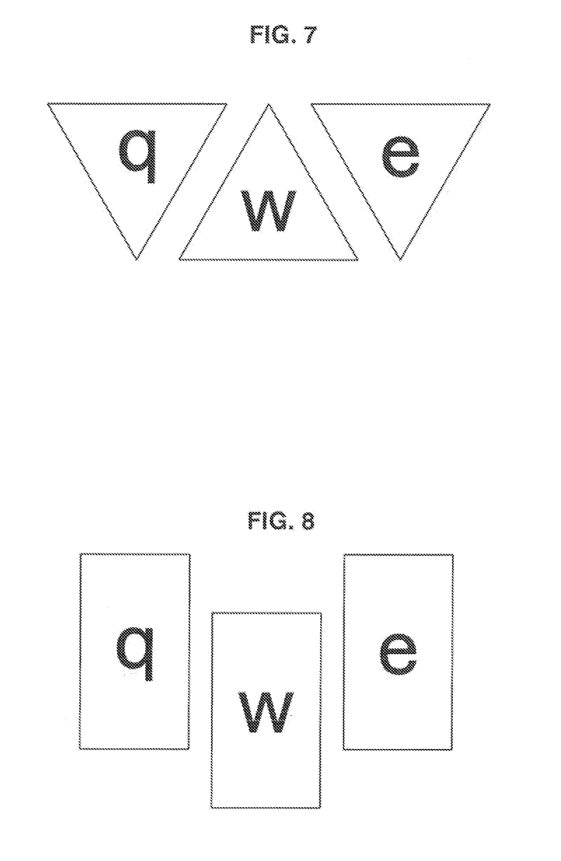

The mode of button display to be controlled by the display controller 115 may also be the sizes (or shapes) of the buttons. For example, there is assumed a button display in which the sizes (or shapes) of the buttons are different from each other depending on the priority calculation techniques associated therewith. In the example shown in FIG. 6, the size (or shape) of the button “q” and the button “e” which are associated with the first priority calculation technique is different from the size (or shape) of the button “w” which is associated with the second priority calculation technique. For example, the size of a button whose contact area needs to be increased may be increased, and the size of a button whose contact area needs to be decreased may be decreased.

Further, the mode of button display to be controlled by the display controller 115 may be the orientations of the buttons. For example, there is assumed a button display in which the orientations of the buttons are different from each other depending on the priority calculation techniques associated therewith. In the example shown in FIG. 7, the orientation of the button “q” and the button “e” which are associated with the first priority calculation technique is different from the orientation of the button “w” which is associated with the second priority calculation technique. For example, the button that needs to lengthen the detection time may be a triangle pointing upward, and the button that needs to shorten the detection time may be a triangle pointing downward.

Further, the mode of button display to be controlled by the display controller 115 may be the placements of buttons. For example, there is assumed a button display in which the placements of the buttons are different from each other depending on the priority calculation techniques associated therewith. In the example shown in FIG. 8, the placement of the button “q” and the button “e” which are associated with the first priority calculation technique is different from the placement of the button “w” which is associated with the second priority calculation technique.

The button display may be determined fixedly, and may be changeable. In the case where the button display is changeable, the display changing part 119 can change the display of at least one button out of the multiple buttons. For example, the display changing part 119 can change the display of at least one button out of the multiple buttons based on a user operation. Here, a case is assumed where the displays of all of the multiple buttons are changed.

A case is assumed where the user operation is detected by the detection device 130, for example, the user operation may also be detected by a device other than the detection device 130. For example, in the case where a post-change display is specified by the user operation, the display changing part 119 changes the button display into the post-change display. Examples of the button display include the displays shown in FIGS. 5 to 8.

Heretofore, functions of the information processing apparatus 10 according to the embodiment of the present disclosure have been described. Next, operation of the information processing apparatus 10 according to the embodiment of the present disclosure will be described.

<1-5. Operation of Information Processing Apparatus>

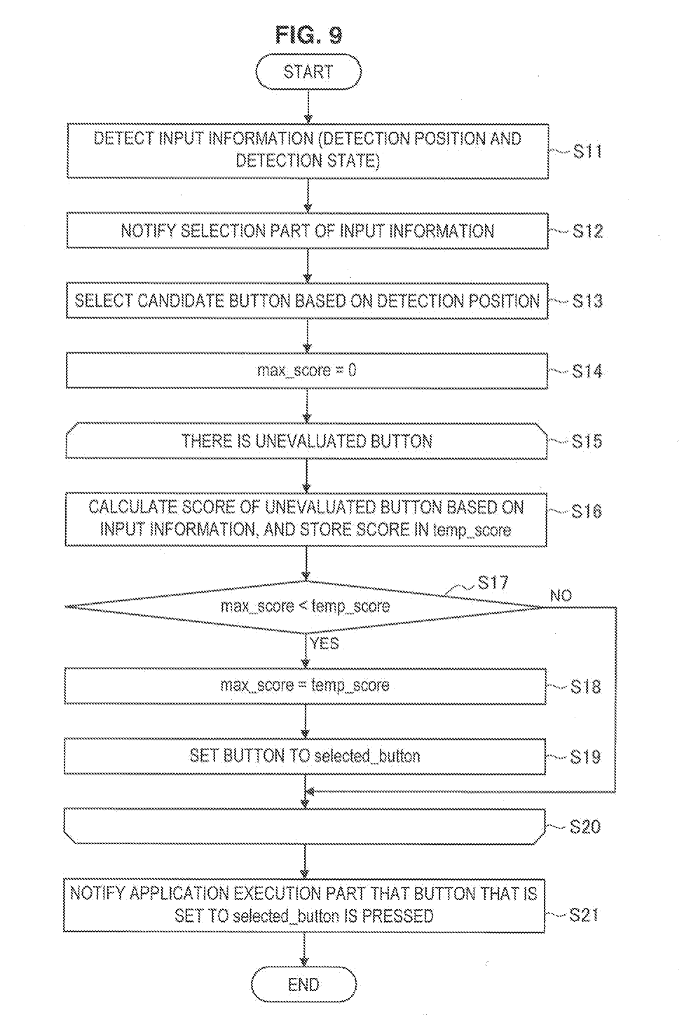

FIG. 9 is a flowchart showing a flow of operation performed by the information processing apparatus 10 according to the embodiment of the present disclosure. Note that, since the operation shown in FIG. 9 merely shows an example of the operation of the information processing apparatus 10, the operation of the information processing apparatus 10 is not limited to the flow of operation shown in FIG. 9.

First, the information processing apparatus 10 detects input information (a detection position and a detection state) (S11). To be specific, the position detector 111 detects a position of an operating object as the detection position, and the state detector 112 detects a state of the operating object as the detection state. The input information is notified to the selection part 116 (S12). The selection part 116 selects a candidate button based on the detection position (S13). For example, the selection part 116 can select the candidate button by excluding some of the multiple buttons from selection targets based on the detection position.

In more detail, the selection part 116 may exclude from the selection targets the buttons that are outside a predetermined range from the detection position. This is because it can be considered that it is less likely that the buttons that are outside the predetermined range from the detection position are the buttons that a user is attempting to specify. It should be noted that, since the operation shown in S13 is performed for enhancing the processing efficiency, the operation may not be performed in particular. The selection part 116 stores “0” in a variable max_score (S14), and repeats S15 to S20 until there is no unevaluated button any more.

The selection part 116 calculates a score of an unevaluated button based on the input information, and stores the calculated score in a variable temp_score (S16). In the case where the value stored in the variable temp_score is not larger than the value stored in the variable max_score (“NO” in S17), the selection part 116 returns to S15. On the other hand, in the case where the value stored in the variable temp_score is larger than the value stored in the variable max_score (“YES” in S17), the selection part 116 stores the value of the variable temp_score in the variable max_score (S18), sets the button to a variable selected_button (S19), and returns to S15.

When there is no unevaluated button any more, the selection part 116 notifies the application execution part 114 that the button that is set to the variable selected_button is pressed (S21). Note that the application execution part 114 causes an application to be executed depending on the pressed button. Further, as described above, the detection history may be used for the score calculation.

Heretofore, operation of the information processing apparatus 10 according to the embodiment of the present disclosure has been described. Here, in the example described above, it has been described that the detection state taken into account for the button selection is not particularly limited. Hereinafter, there will be further described a specific example of the button selection function using as an example the case where a pressure is used as the detection state.

<1-6. Specific Example of Button Selection Function>

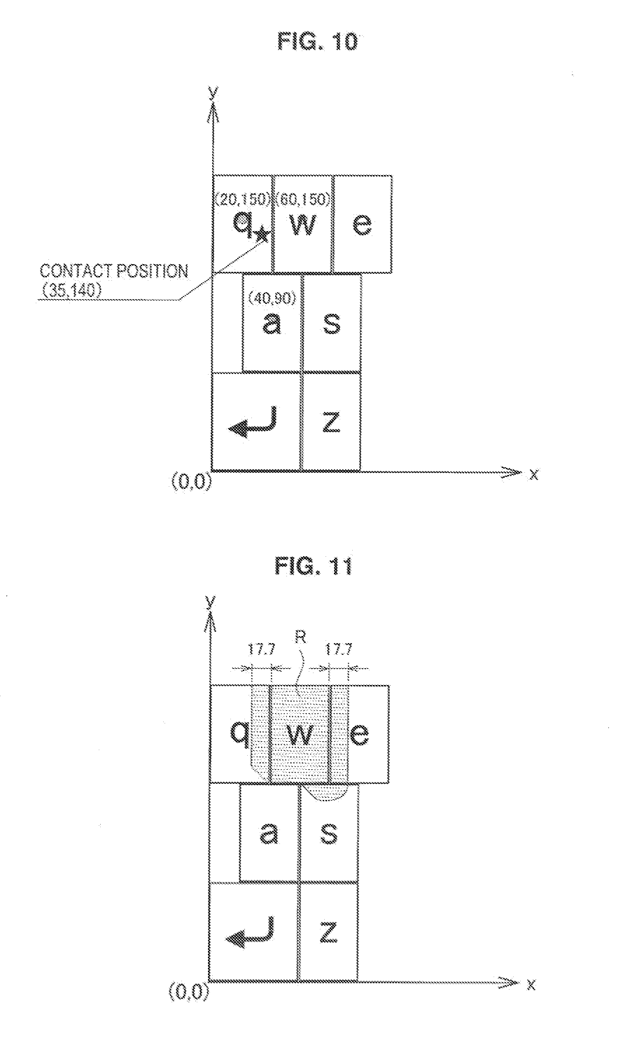

FIG. 10 is a diagram illustrating a specific example of the button selection function. Note that, for simplicity of the description, FIG. 10 shows a recognition region of a part of the button group 141 shown in FIG. 1. As shown in FIG. 10, each button is associated with a priority calculation technique. To be specific, the buttons “q”, “e”, “s”, “Enter” are each associated with the first priority calculation technique, and the buttons “w”, “a”, and “z” are each associated with the second priority calculation technique.

Here, for example, a case is assumed where the first priority calculation technique is a technique that calculates the priority to be higher as the pressure decreases, and the second priority calculation technique is a technique that calculates the priority to be higher as the pressure increases. However, the priority calculation technique is not limited thereto. The respective values to be used for the description are represented as follows.

XD: x-coordinate of detection position

YD: y-coordinate of detection position

P: pressure (maximum detectable pressure is “1”)

D(q), D(w), D(a): value calculated based on detection position

Q(q), Q(w), Q(a): value (priority) calculated based on pressure

S(q), S(w), S(a): score of button

In the score calculation technique, the score of each button is calculated using:

S(x)=D(x)*Q(x)

and a button having the largest score is selected.

Size of button: width 40, height 60

Coordinates of center of button “q”=(20,150)

Coordinates of center of button “w”=(60,150)

Coordinates of center of button “a”=(40,90)

Formula for calculating D differs depending on whether the detection position is inside a button.

In a case where the detection position is inside the button
The shortest distance from the detection position to the edge of the button is represented by Din.

D=400+Din²

(provided that “400” is changeable as appropriate)
Example: In a case of the button “q”, since XD is 35 and the x-coordinate of the right edge of the button “q” is 40, Din=40−35=5

D=400+5²=425

In a case where the detection position is outside the button
The shortest distance from the detection position to the button is represented by Dout.

D=400−Dout²
Example: In a case of the button “a”, since YD is 140 and the y-coordinate of the upper edge of the button “a” is 120, Dout=140−120=20

D=400−20²=0

Formula for calculating Q differs depending on a button.

Buttons “w” and “a”, which are liable to be selected when the pressure is great

Q(w)=Q(a)=P²+0.1

Button “q”, which is liable to be selected when the pressure is small

Q(q)=(1−P)²+0.1

In the formula for calculating Q, when P=0.5, the pressure is neither great nor small, and it is set as follows:

Q(w)=Q(q)=Q(a).

Let us assume that, as shown in FIG. 10, the detection position (XD=35, YD=140) is input to the software keyboard described above. In this case, the scores to be calculated and the buttons to be selected based on the scores are shown for the following three cases: P=0.1 (when the pressure is small); P=0.9 (when the pressure is great); and P=0.5 (when the pressure is neither small nor great).

(1) P=0.11 (when the Pressure is Small)

D(q)=400+(40−35)²=425

D(w)=400−(40−35)²=375

D(a)=400−(140−120)²=0

Q(q)=(1−0.1)²+0.1=0.91

Q(w)=Q(a)=(0.1)²+0.1=0.1

S(q)=D(q)*Q(q)=425*0.91=386.75

S(w)=D(w)*Q(w)=375*0.11=41.25

S(a)=D(a)*Q(a)=0*0.11=0

The button “q” is selected.

(It is determined that the button “q” is optimum from the viewpoints of both the detection position and the pressure.)

(2) P=0.9 (when the Pressure is Great)
The values of D's are the same as (1).

Q(q)=(1−0.9)²+0.1=0.11

Q(w)=Q(a)=(0.9)²+0.1=0.91

S(q)=D(q)*Q(q)=425*0.11=46.75

S(w)=D(w)*Q(w)=375*0.91=341.25

S(a)=D(a)*Q(a)=0*0.91=0

The button “w” is selected.

(It is determined that the button “q” is optimum from the viewpoint of the detection position, the buttons “w” and “a” are optimum from the viewpoint of the pressure, and hence, the button “w” is determined as optimum overall.)

(3) P=0.5 (when the Pressure is Neither Great Nor Small)

The values of D's are the same as (1).

Q(q)=(1−0.5)²+0.1=0.35

Q(w)=Q(a)=(0.5)²+0.1=0.35

S(q)=D(q)*Q(q)=425*0.35=148.75

S(w)=D(w)*Q(w)=375*0.35=131.25

S(a)=D(a)*Q(a)=0*0.35=0

The button “q” is selected.

(It is determined that the button “q” is optimum from the viewpoint of the detection position, there is no difference from the viewpoint of the pressure, and hence the button “q” is determined as optimum overall.)

In this way, the button selection is performed based on both the detection position and the detection state (for example, pressure). In the above, there has been described an example of the case where the pressures differ on the same coordinates. Next, a recognition region of a specific button under a specific detection state will be described. FIG. 11 is a diagram showing a recognition region of a specific button under a specific detection state. Here, the following description is made assuming that the pressure as an example of the detection state is fixed (for example, P=0.9).

A recognition region R shown in FIG. 11 is, when P=0.9, the range of the detection position for the button “w” to be selected, that is, the recognition region of the button “w”. As shown in FIG. 11, when the pressure is P=0.9, for example, even when the detection position is away from the button “w” by 17.7 in the left and right directions, the button “w” is selected. In this example, the area of the recognition region of the button “w” is slightly less than twice the area of the display part of the button “w”.

In this way, since the recognition region of a desired button is increased by the user intentionally adjusting the pressure, the remarkable effect can be expected that the erroneous selection caused by the shift of the detection position can be prevented. Note that, when the detection position is away from the button “w” by 17.7, the button “w” is selected, because S(q) and S(w) are calculated as follows.

S(q)=(400+17.7²)*0.11=78.5

S(w)=(400−17.7²)*0.91=78.9

S(q)<S(w)

Heretofore, there has been described a specific example of the button selection function using as an example the case where the pressure is used as the detection state. Here, in the example described above, the case in which the number of the detection positions is one has been mainly described. However, there is also assumed a case where the number of the detection positions is two or more. Hereinafter, there will be described operation of the information processing apparatus 10 in the case where the number of the detection positions is two or more.

<1-7. Operation of Information Processing Apparatus (Multiple Inputs)>

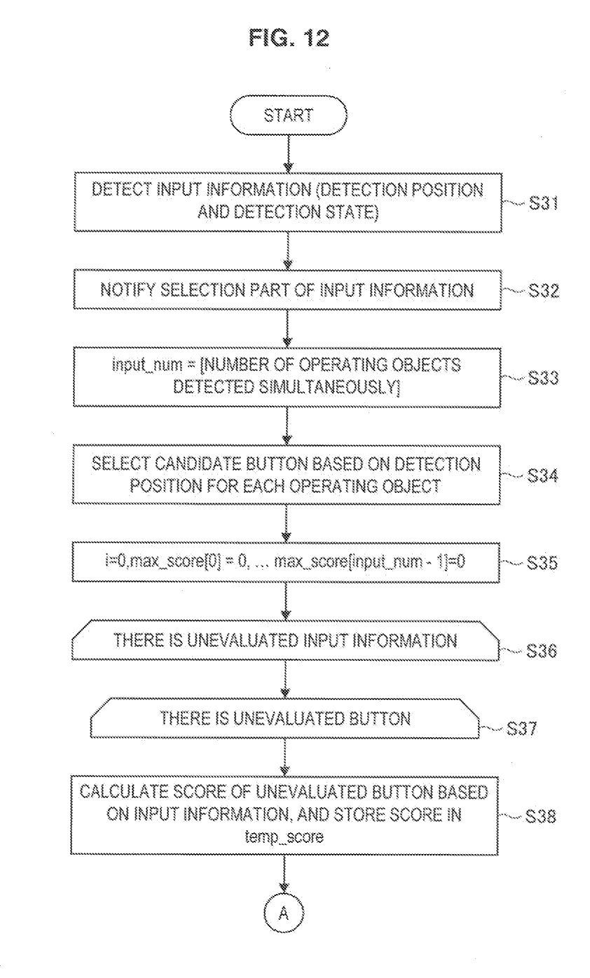

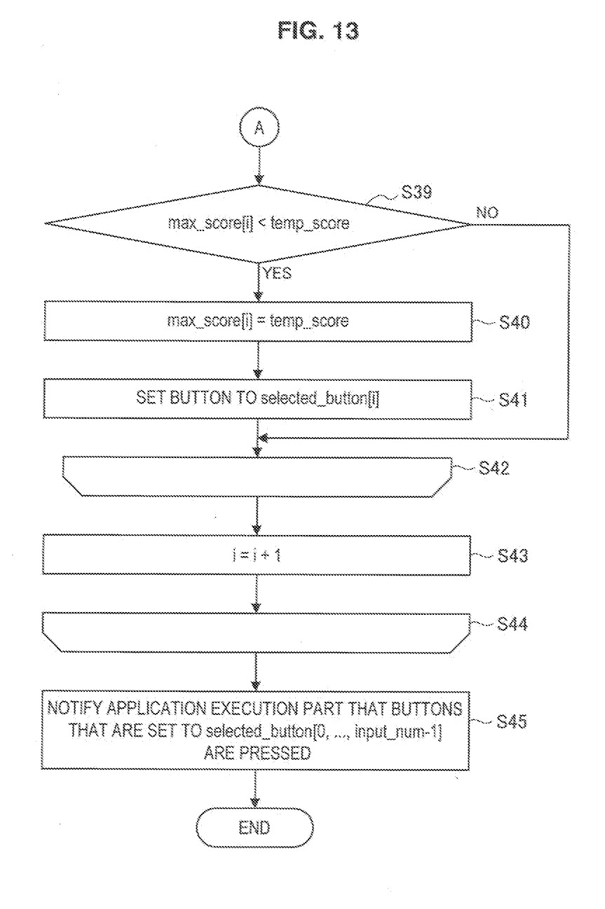

FIG. 12 and FIG. 13 are each a flowchart showing a flow of operation (in a case of executing multiple inputs) performed by the information processing apparatus 10 according to the embodiment of the present disclosure. Note that, since the operation shown in each of FIG. 12 and FIG. 13 merely shows an example of the operation of the information processing apparatus 10, the operation of the information processing apparatus 10 is not limited to the flow of operation shown in FIG. 12 and FIG. 13.

First, the information processing apparatus 10 detects input information (a detection position and a detection state) (S31). To be specific, the position detector 111 detects a position of an operating object as the detection position, and the state detector 112 detects a state of the operating object as the detection state. The input information is notified to the selection part 116 (S32). The selection part 116 stores the number of operating objects that are detected simultaneously in input_num (S33), and the selection part 116 selects a candidate button based on the detection position for each operating object (S34). For example, the selection part 116 can select the candidate button by excluding some of the multiple buttons from selection targets based on the detection position for each operating object.

In more detail, the selection part 116 may exclude from the selection targets the buttons that are outside a predetermined range from the detection position. This is because it can be considered that it is less likely that the buttons that are outside the predetermined range from the detection position are the buttons that a user is attempting to specify. It should be noted that, since the operation shown in S34 is performed for enhancing the processing efficiency, the operation may not be performed in particular. The selection part 116 stores “0” in a variable i and variables max_score[0] to [input_num−1](S35), and repeats S36 to S44 until there is no unevaluated button any more.

The selection part 116 calculates a score of an unevaluated button based on the input information, and stores the calculated score in a variable temp_score (S38). In the case where the value stored in the variable temp_score is not larger than the value stored in the variable max_score[i](“NO” in S39), the selection part 116 returns to S37. On the other hand, in the case where the value stored in the variable temp_score is larger than the value stored in the variable max_score[i](“YES” in S39), the selection part 116 stores the value of the variable temp_score in the variable max_score[i](S40), sets the button to a variable selected_button[i](S41), and returns to S37.

When there is no unevaluated button any more, the selection part 116 adds one to the variable i (S43), returns to S36, and continues operation on unevaluated input information. When there is no unevaluated input information any more, the selection part 116 notifies the application execution part 114 that the buttons that are set to the variables selected_button[0] to [input_num−1] are pressed (S45). Note that the application execution part 114 causes an application to be executed depending on the pressed button. Further, as described above, the detection history may be used for the score calculation.

As shown in FIG. 12 and FIG. 13, in the case where a combination of a detection position and a detection state is detected for each of the multiple operating objects, the selection part 116 may select any one of the multiple buttons based on the combination and the priority calculation technique associated with each of the multiple buttons. The number of buttons to be selected is not particularly limited. For example, as shown in FIG. 12 and FIG. 13, the selection part 116 may select buttons, the number of which is equal to the number of the combinations, from the multiple buttons. For example, such selection can be applied to the case where an upper limit for the number of buttons that can be input simultaneously is not determined, such as a piano application.

However, there is also a case where an upper limit for the number of buttons that can be input simultaneously is already determined depending on an application. For example, when using a software keyboard, there is a case where the upper limit is set to “2” in order to press a “SHIFT” key and an alphabet key simultaneously. In such a case, the selection part 116 may select buttons, the number of which has been determined in advance, from the multiple buttons.

In the example shown in FIG. 12 and FIG. 13, the selection part 116 may reduce the number of pressed buttons down to the upper limit in accordance with a rule that has been determined in advance, before notifying the application execution part 114 of the pressed buttons. The rule may be a rule that simply gives priority to a button having a high score, or may be a rule unique to an application that gives priority to a combination of keys that has been determined in advance. The combination of keys that has been determined in advance may be a combination of keys which have a meaning in being pressed simultaneously (for example, a combination of a “SHIFT” key and an “Alt” key on the software keyboard), for example.

### 2. CONCLUSION

As described above, according to the embodiment of the present disclosure, there is provided the information processing apparatus 10 including the position detector 11 configured to detect a position of an operating object as a detection position, the state detector 112 configured to detect a state of the operating object as a detection state, and the selection part 116 configured to select any one of multiple objects based on the detection position, the detection state, and a priority calculation technique associated with each of the multiple objects.

According to such a configuration, when any one of the multiple objects is selected, since not only the detection position but also the detection state of the operating object and the priority calculation technique based on the detection state are taken into account, the possibility of occurrence of object erroneous selection can be reduced. Therefore, the decrease in input speed for selecting an object can be suppressed regardless of the density of objects.

It should be understood by those skilled in the art that various modifications, combinations, sub-combinations and alterations may occur depending on design requirements and other factors insofar as they are within the scope of the appended claims or the equivalents thereof.

Further, the respective steps included in the operation of the information processing apparatus 10 of the present specification are not necessarily processed in a time-series order in accordance with the flowcharts. For example, the respective steps included in the operation of the information processing apparatus 10 may be processed in different order from the flowcharts, or may be processed in a parallel manner.

Further, it is also possible to create a computer program for causing hardware such as a CPU, ROM, and RAM, which are built in the information processing apparatus 10, to exhibit substantially the same functions as those of respective structures of the information processing apparatus 10 described above. Further, there is also provided a storage medium having the computer program stored therein.

Additionally, the present technology may also be configured as below.

(1) An information processing apparatus including:

a position detector configured to detect a position of an operating object as a detection position;

a state detector configured to detect a state of the operating object as a detection state; and

a selection part configured to select any one of a plurality of objects based on the detection position, the detection state, and a priority calculation technique associated with each of the plurality of objects.

(2) The information processing apparatus according to (1),

wherein the selection part selects any one of the plurality of objects further based on a position of each of the plurality of objects.

(3) The information processing apparatus according to (1) or (2) further including

a display controller configured to control a display of at least one object out of the plurality of objects in a manner that the at least one object is a display corresponding to a priority calculation technique associated with the at least one object.

(4) The information processing apparatus according to (3),

wherein the display of the object includes at least one of a color, a size, a shape, an orientation, and a placement of the object.

(5) The information processing apparatus according to any one of (1) to (4), further including

a calculation technique changing part configured to change a priority calculation technique associated with at least one object out of the plurality of objects.

(6) The information processing apparatus according to (5),

wherein the calculation technique changing part changes the priority calculation technique based on a user operation.

(7) The information processing apparatus according to (5),

wherein the calculation technique changing part changes the priority calculation technique based on a detection history of the operating object.

(8) The information processing apparatus according to (7),

wherein the detection history includes at least one of a history of the detection position previously detected by the position detector and a history of the detection state previously detected by the state detector.

(9) The information processing apparatus according to (5),

wherein the calculation technique changing part changes the priority calculation technique based on a history of correction that a user performed on an object previously selected by the selection part.

(10) The information processing apparatus according to any one of (1) to (9), further including

a display changing part configured to change a display of at least one object out of the plurality of objects based on a user operation.

(11) The information processing apparatus according to any one of (1) to (9),

wherein, when a combination of a detection position and a detection state is detected for each of a plurality of operating objects, the selection part selects any one of a plurality of objects based on the combination and a priority calculation technique associated with each of the plurality of objects.

(12) The information processing apparatus according to (11),

wherein the selection part selects an object, a number of which is equal to a number of the combinations, from the plurality of objects.

(13) The information processing apparatus according to (11),

wherein the selection part selects objects, a number of which has been determined in advance, from the plurality of objects.

(14) The information processing apparatus according to any one of (1) to (13),

wherein the selection part excludes some of the plurality of objects from selection targets based on the detection position.

(15) The information processing apparatus according to any one of (1) to (14),

wherein the detection state includes at least a time taken to detect the operating object by a detection device, a pressure applied by the operating object to the detection device, and a contact area between the detection device and the operating object.

(16) The information processing apparatus according to any one of (1) to (15),

wherein each of the plurality of objects is associated with a priority calculation technique that is different from a priority calculation technique with which an adjacent object is associated.

(17) An information processing method including:

detecting a position of an operating object as a detection position;

detecting a state of the operating object as a detection state; and

selecting any one of a plurality of objects based on the detection position, the detection state, and a priority calculation technique associated with each of the plurality of objects.

(18) A program for causing a computer to function as an information processing apparatus including

a position detector configured to detect a position of an operating object as a detection position,

a state detector configured to detect a state of the operating object as a detection state, and

a selection part configured to select any one of a plurality of objects based on the detection position, the detection state, and a priority calculation technique associated with each of the plurality of objects.

The present disclosure contains subject matter related to that disclosed in Japanese Priority Patent Application JP 2012-107318 filed in the Japan Patent Office on May 9, 2012, the entire content of which is hereby incorporated by reference.

What is claimed is:

1. An information processing apparatus comprising:
a position detector configured to detect a position of an operating object as a detection position;
a state detector configured to detect a state of the operating object as a detection state; and
a selection part configured to select any one of a plurality of objects based on the detection position, the detection state, and a priority calculation technique associated with each of the plurality of objects.

2. The information processing apparatus according to claim 1,
wherein the selection part selects any one of the plurality of objects further based on a position of each of the plurality of objects.

3. The information processing apparatus according to claim 1, further comprising
a display controller configured to control a display of at least one object out of the plurality of objects in a manner that the at least one object is a display corresponding to a priority calculation technique associated with the at least one object.

4. The information processing apparatus according to claim 3,
wherein the display of the object includes at least one of a color, a size, a shape, an orientation, and a placement of the object.

5. The information processing apparatus according to claim 1, further comprising
a calculation technique changing part configured to change a priority calculation technique associated with at least one object out of the plurality of objects.

6. The information processing apparatus according to claim 5,
wherein the calculation technique changing part changes the priority calculation technique based on a user operation.

7. The information processing apparatus according to claim 5,
wherein the calculation technique changing part changes the priority calculation technique based on a detection history of the operating object.

8. The information processing apparatus according to claim 7,
wherein the detection history includes at least one of a history of the detection position previously detected by the position detector and a history of the detection state previously detected by the state detector.

9. The information processing apparatus according to claim 5,
wherein the calculation technique changing part changes the priority calculation technique based on a history of correction that a user performed on an object previously selected by the selection part.

10. The information processing apparatus according to claim 1, further comprising
a display changing part configured to change a display of at least one object out of the plurality of objects based on a user operation.

11. The information processing apparatus according to claim 1,
wherein, when a combination of a detection position and a detection state is detected for each of a plurality of operating objects, the selection part selects any one of a plurality of objects based on the combination and a priority calculation technique associated with each of the plurality of objects.

12. The information processing apparatus according to claim 11,
wherein the selection part selects an object, a number of which is equal to a number of the combinations, from the plurality of objects.

13. The information processing apparatus according to claim 11,
wherein the selection part selects objects, a number of which has been determined in advance, from the plurality of objects.

14. The information processing apparatus according to claim 1,
wherein the selection part excludes some of the plurality of objects from selection targets based on the detection position.

15. The information processing apparatus according to claim 1,
wherein the detection state includes at least a time taken to detect the operating object by a detection device, a pressure applied by the operating object to the detection device, and a contact area between the detection device and the operating object.

16. The information processing apparatus according to claim 1,
wherein each of the plurality of objects is associated with a priority calculation technique that is different from a priority calculation technique with which an adjacent object is associated.

17. An information processing method comprising:
detecting a position of an operating object as a detection position;
detecting a state of the operating object as a detection state; and
selecting any one of a plurality of objects based on the detection position, the detection state, and a priority calculation technique associated with each of the plurality of objects.

18. A program for causing a computer to function as an information processing apparatus including
a position detector configured to detect a position of an operating object as a detection position,
a state detector configured to detect a state of the operating object as a detection state, and
a selection part configured to select any one of a plurality of objects based on the detection position, the detection state, and a priority calculation technique associated with each of the plurality of objects.
